(19) United States
(12) Patent Application Publication
(10) Pub. No.: US 2015/0313188 A1
(43) Pub. Date: Nov. 5, 2015

(54) Bag

(71) Applicants: Marvin Seller, New York, NY (US); Gary Blum, Nanuet, NY (US)

(72) Inventors: Marvin Seller, New York, NY (US); Gary Blum, Nanuet, NY (US)

(21) Appl. No.: 14/702,410

(22) Filed: May 1, 2015

Related U.S. Application Data
(60) Provisional application No. 61/987,405, filed on May 1, 2014.

(51) Int. Cl. A01K 23/00

(52) U.S. Cl. CPC A01K 23/005

(57) ABSTRACT

A bag is provided formed of a liquid impermeable material, where the bag has an opening edge with a channel located at the opening edge, and a flap of material extending from the channel. An elongated closure string is provided within the channel, where the closure string can be used to seal the bag, enabling the transportation of liquid or solid waste.

### FIELD OF INVENTION

The present invention is in the field of bags, specifically bags used for pet waste removal.

### BACKGROUND

Today, most public areas require, usually by statute, dog owners to dispose of their pet's droppings in a sanitary manner. The most common methods existing today are either cumbersome and unsanitary “scoop and drop” devices, or unsavory manual pick up by hand, utilizing plastic bag.

Existing devices and methods for removal of pet waste involve the pet handler to wait for their pet to deposit excrement on the ground, and then the pet handler picks up the excrement, often using a plastic bag or protective glove. Such methods are inefficient, leaving waste particles on the ground or other surface, as well as requiring the pet handler to grasp waste with their hand, albeit through a bag or glove.

### SUMMARY OF THE INVENTION

The present invention provides an improved collection bag for handling pet waste, removing the need for a pet handler/user to come into contact with the pet waste. The bag is a drawstring bag designed to be used with a frame. The drawstring bag has an extended exterior flap allowing for secure placement on the frame. The bag is intended for the pet handler/user to place the bag (preferably in a frame) behind the pet while the pet is in the process of excreting, allowing the waste to enter the bag. The pet handler/user may then pull the draw string to close the bag and may dispose of the waste filled bag without touching the body of the bag.

### BRIEF DESCRIPTION OF THE DRAWINGS

FIG. 1 is a side view of the bag of the invention.

FIG. 2 is a top elevation view of the bag of the invention.

FIG. 3 is a perspective view of the invention, showing the bag attached to the frame.

FIG. 4 is a top elevation view of the invention, showing the bag attached to the frame.

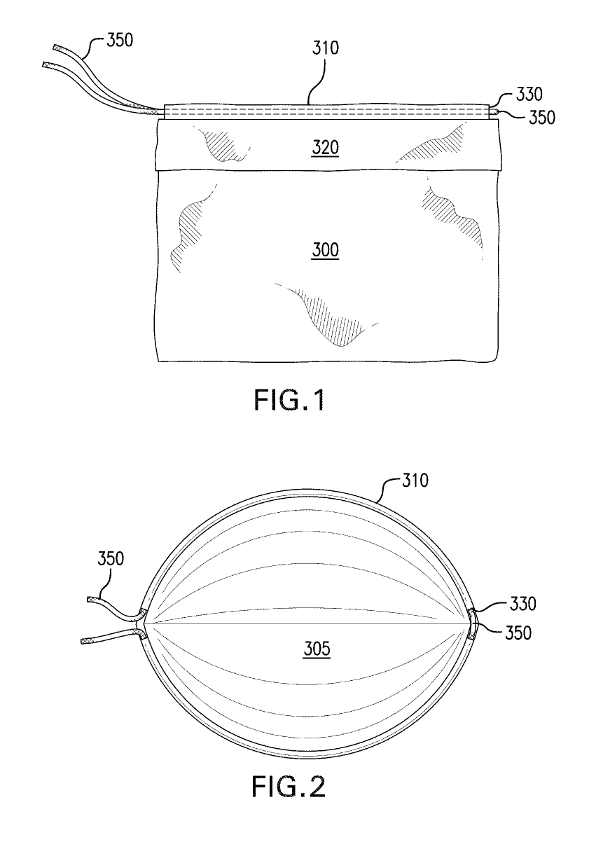

### DETAILED DESCRIPTION OF THE PREFERRED EMBODIMENT

The invention consists of a bag 300 with a drawstring closure, designed for use in pet waste removal.

The bag 300 is formed of two side panels connected at their bottom and sides, forming a bag opening at the top. The bag opening is approximately the size of the frame, with a channel 310 extending along the bag opening, allowing an elongated closure string 350 to pass therein. Preferably, bag 300 is comprised of plastic or other liquid impermeable material. In a preferred embodiment, bag 300 formed of two rectangular pieces of plastic, sealed at three of the four sides of the rectangles, with channel 310 surrounding the open sides.

A flap 320 is connected to the bag 300 at the opening, extending parallel to the sides of the bag. Preferably, the flap extends along the length of the bag opening, and the width of the flap extends at least ½ inch from the bag opening. A wider flap aids in securing bag 300 on the frame. In a preferred embodiment, at least one edge of the flap is attached to an edge of a side panel of the bag, forming a pocket between the side panel and the flap. Flap 20 may be comprised of two separate flaps, one on each side of bag 300.

A distinctive feature of the invention is the positioning of flap 320 adjacent to the channel 310 and relative to the opening of bag 300. Prior art string bags have cords or string sealed at a channel at the opening of the bag, but such bags cannot work for the purposes of the invention. Flap 320 provides weight and resistance to allow bag 300 to be placed on a frame, with the body of bag 300 within the frame, channel 310 resting on the frame, and flap 320 extending over the frame. This allows the bag to sit on the frame without falling off, and positions the closure string 350 atop the frame for easy removal with a pull of the string.

As an optional feature, removable securing means can be applied to flap 320, allowing flap 320 to be removably attached to the side of bag 300. Examples of such removable securing means include adhesive strips, snaps, fasteners or similar means as are known in the art.

The elongated closure string 350 of the flexible bag 300 preferably extends through a channel 310 adjacent to the opening of the bag 300, with the ends of the closure string 350 extending outward from an opening in channel 310. Channel 310 may have two openings proximate to each other, or may have open gaps along the periphery of the bag opening. In a preferred embodiment, channel 310 is open at one point on the bag, allowing ends of closure string 350 to extend outward, and also includes a gap 330 at a point opposite this opening.

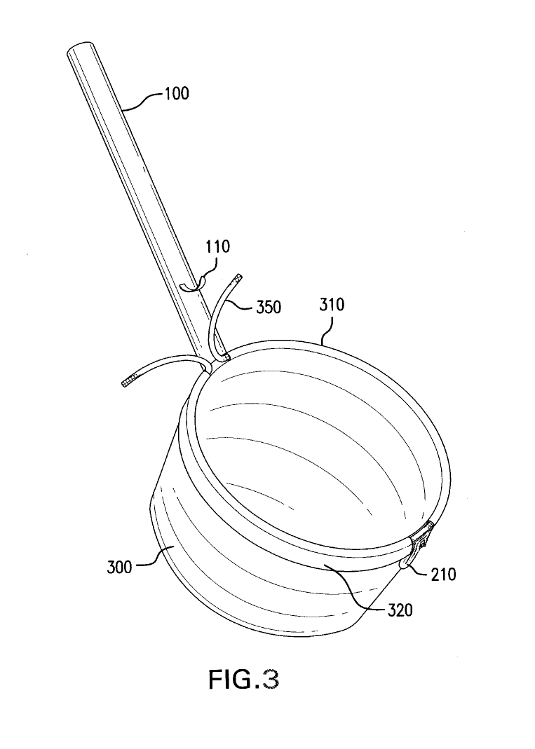

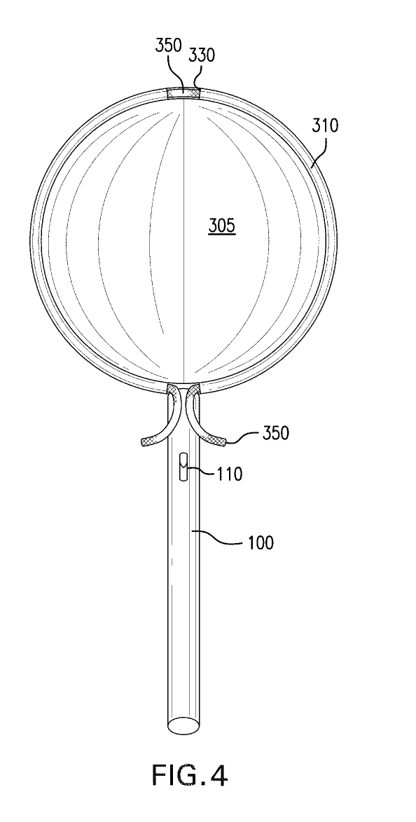

Preferably, a pet handler/user places the bag 300 in the center of a frame or similar structure as shown in FIG. 3, with the flap 320 placed over the perimeter of the frame. The ends of closure string 350 may be tied together or otherwise secured.

Upon noticing that the pet is preparing to defecate, the pet handler/user extends the invention such that bag 300 is directly under the pet's posterior, so that the feces are deposited directly into the interior 305 of bag 300, instead of on the ground. After the pet has finished defecation, the pet handler/user moves entire device away from the pet.

The pet handler/user pulls on the ends of closure string 350 to close the bag 300. This action also serves to remove bag 300 from the frame. The bag 300 may now be safely and sanitarily released and deposited into a convenient receptacle.

A key advantage of the present invention over prior art approaches is that due to the use of a removable bag, the present invention provides a more hygienic solution. Unlike prior art “scooper” devices, the main body of the invention does not come into contact with feces, and therefore will not need antiseptic cleaning. Further, unlike other bag-based solutions, the user of the present invention will not need to grasp the feces through the bag, a discomforting feeling, even if no actual contact is made. A user of the present invention will only need to grasp the ends of closure string 350 to pull bag 300 closed, and can then deposit bag 300 into a waste receptacle, all without the discomfort of being in contact with feces, even through a bag.

The invention can be used for more than collecting animal waste. Other uses include collecting fish from an aquarium tank; or catching insects, birds, or rodents. For certain applications, bag 300 could be made of a net or mesh material.

While certain novel features of the present invention have been shown and described, it will be understood that various omissions, substitutions and changes in the forms and details of the device illustrated and in its operation can be made by those skilled in the art without departing from the spirit of the invention.

We claim:

1. A bag comprising:
two side panels attached at their peripheries, with an opening formed by an unattached edge of the sides,
a channel formed along the opening,
an elongated flexible closure extending through the channel; and
a flap extending longitudinally along the opening, and extending away from the opening.

2. The bag of claim 1, where the bag is comprised of a liquid impermeable material.

3. A bag comprising:
a rectangular panel of a pliable material;
a channel formed by folding a portion of the rectangular panel along one linear axis of the rectangular panel against itself and creating a seam, the channel forming an opening of the bag;
a flap formed adjacent to the seam; and
an elongated closure string placed within the channel.

4. The bag of claim 2, where the flap has a length comparable to the opening of the bag and a width greater than ½ inch.

5. The bag of claim 2, where the bag is comprised of a liquid impermeable material.
